(19) United States
(12) Patent Application Publication
(10) Pub. No.: US 2006/0214755 A1
(43) Pub. Date: Sep. 28, 2006

(54) Magnetic device

(76) Inventor: Wan-Hsiu Huang, Hsinchu City (TW)

Correspondence Address: LIN & ASSOCIATES INTELLECTUAL PROPERTY, P.O. BOX 2339, SARATOGA, CA, 95070-0339, US

(21) Appl. No.: 11/211,338

(22) Filed: Aug. 25, 2005

(30) Foreign Application Priority Data
Mar. 23, 2005 (TW) 094204521

(51) Int. Cl. H01F 7/02

(52) U.S. Cl. 335/306

(57) ABSTRACT

A magnetic device is provided, including two magnets and an adjusting structure between the two magnets. The two magnets are placed to face each other with their opposite poles so that the magnets are attracted to each other. The adjusting structure is placed between the two magnets to provide the control over the distance between the two magnets. The adjusting structure also prevents the fuel pipe from long term jamming or crashing forces caused by a tightly clamping magnetic device. In addition, the fluid inside the pipe or the hose can be magnetized for better combustion efficiency.

### FIELD OF THE INVENTION

The present invention generally relates to a magnetic device for fuel, and more specifically to a magnetic device for easier attachment to fuel pipes and improving fuel combustion.

### BACKGROUND OF THE INVENTION

Cars are one of the most popular means for transportation. The power source of a car comes from the combustion of fuel. If the fuel is completely combusted, the energy provided by the combustion is greater. On the other hand, if the fuel is not completely combusted, the fuel consumption increases as the efficiency decreases and a larger amount of CO will be released to pollute the air. It is therefore important for car manufacturer to research for improvement in fuel combustion.

Conventional techniques for improving the fuel combustion efficiency can be divided into two major categories. The first category is to use ultra infrared mineral in the fuel to refine the fuel molecules so that the reaction with oxygen molecules during the combustion will be more complete The disadvantage of this approach is that the mineral must be directly placed inside the fuel tank or the fuel must be sure to pass the mineral for a long period of time to improve the reaction. The second category is to use the magnetization. By placing a magnetic material along the path of the fuel flow, the fuel molecules will be magnetized so that the oil-gas mixture has a more uniform structure for better combustion. The second category is in the mainstream of the application. However, as the technique requires a more complicated structure, it is imperative to develop a magnetic device with a simple structure and easy to use.

### SUMMARY OF THE INVENTION

The present invention has been made to overcome the above-mentioned drawback of conventional magnetic devices. The primary object of the present invention is to provide a magnetic device with a simple structure and easy to use. By using two magnets having their opposite poles facing each other, the magnets of the magnetic device can fit on the opposite sides of a fuel pipe. The magnetic field magnetizes the fuel flowing through the pipe so that the combustion will be more complete to save the fuel and increase the power.

Another object of the present invention is to provide an inexpensive magnetic device. Although the primary element, the magnets, of the present invention requires special manufacturing. The other elements, including the screw and the screw cap, are both inter-exchangeable off-the-shelf parts. Therefore, the manufacturing cost of the magnetic device of the present invention is competitive in the market.

Yet another object of the present invention is to provide a magnetic device that is easier and safer to install. By using an adjusting structure between the two magnets, the installation of the magnetic device is easier and safer. In addition, the adjusting structure can effectively control the distance between the two magnets so that the magnetic device can be applied to different types of pipes, such as soft hose for gas or water. The adjusting structure also prevents the fuel pipe from long term jamming or crashing forces caused by a tightly clamping magnetic device.

Another object of the present invention is to provide a magnetic device applicable to a wide range of situations. With the adjusting structure, the magnetic device can be used with fuel pipe/hose, gas pipe/hose, water pipe/hose, and so on. In the meantime, the fluid inside the pipe or the hose can be magnetized for better efficiency.

To achieve the objects, the present invention provides a magnetic device, including two magnets and an adjusting structure between the two magnets. The two magnets are placed to face each other with their opposite poles so that the magnets are attracted to each other. The adjusting structure is placed between the two magnets to provide the control over the distance between the two magnets.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the present invention;

FIG. 2 shows an exploded view of the structure shown in FIG. 1;

FIG. 3 shows a schematic view of a second embodiment of the present invention;

FIG. 4 shows a cross-sectional view of an embodiment with screw caps added to the ends of the screw;

FIG. 5 shows a cross-sectional view of a third embodiment of the present invention;

FIG. 6 shows a schematic view of a fourth embodiment of the present invention;

FIG. 7 shows a schematic view of including a cross-section of the fourth embodiment shown in FIG. 6;

FIG. 8 shows a schematic view of the installation process for the present invention;

FIG. 9 shows a schematic view of a fifth embodiment of the present invention; and

FIG. 10 shows a cross-sectional view of the fifth embodiment shown in FIG. 9.

### DETAILED DESCRIPTION OF THE PREFERRED EMBODIMENTS

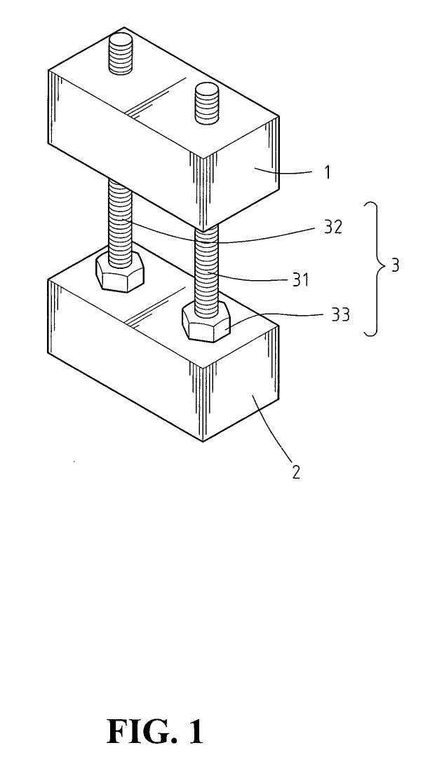

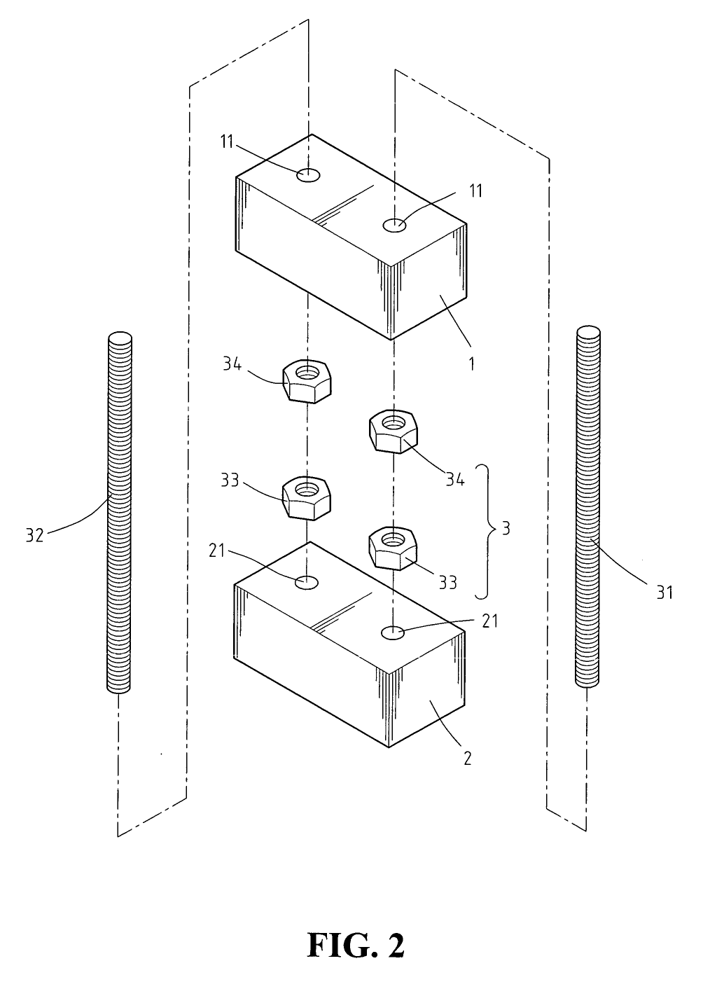

FIG. 1 and FIG. 2 show different view of a magnetic device of the present invention. The magnetic device includes two magnets 1, 2 and an adjusting structure 3 placed between magnets 1, 2.

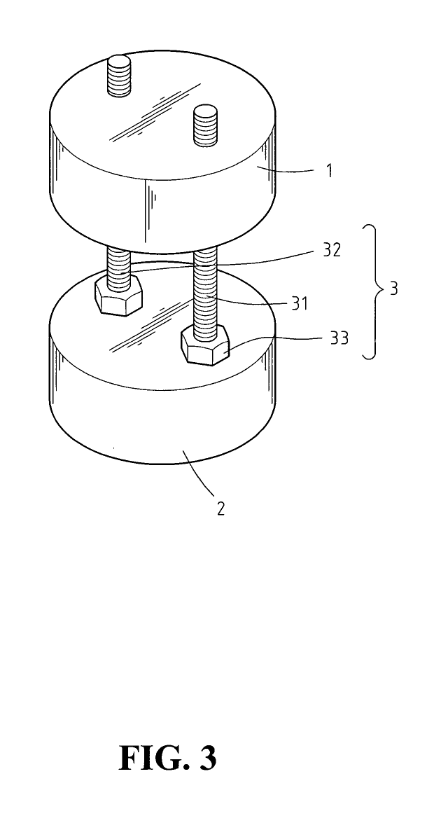

Magnets 1,2 are made of magnetic materials, and can be of any shape, such as a cube, a rectangular block of this embodiment shown in FIG. 1 and FIG. 2, or a round shape or oval shape of the embodiment shown in FIG. 3. The material can be permanent magnet or other magnetic material with strong magnetic characteristics. The embodiments of the present invention use the powder metallurgy to manufacture the magnets. The magnets have strong magnetic forces, with one side as N pole, and the other side S pole. The two magnets can be of the same shape so that the manufacture costs can be reduced.

Adjusting structure 3 is placed between magnets 1, 2 for controlling the distance between magnets 1, 2 and preventing magnets 1, 2 from moving. Adjusting structure 3 is not limited to any specific structure as long as the structure provides control over the distance. The following shows various embodiments of the adjusting structure of the present invention.

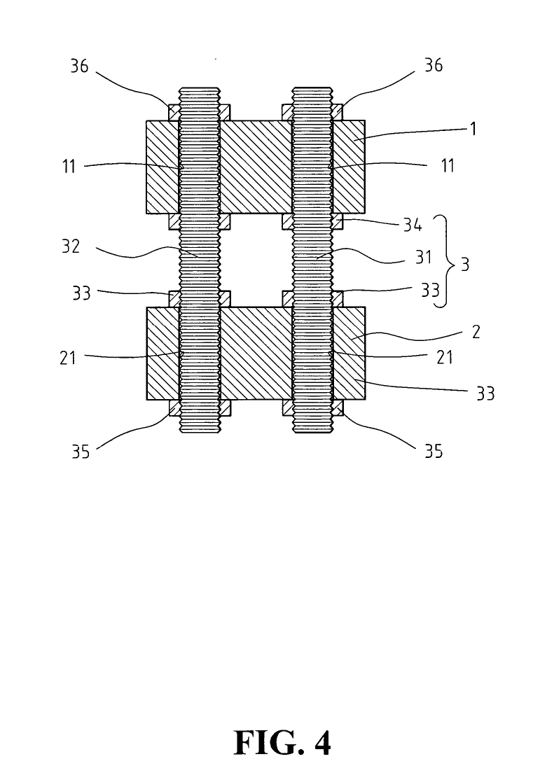

FIG. 2 shows adjusting structure 3, including two screws 31, 32 and a plurality of screw caps 33, 34. Magnets 1, 2 include holes 11, 21, and screws 31, 32 penetrate magnets 1, 2 through holes 11, 12. Screw caps 33, 34 are placed on screws 31, 32 at the location between magnets 1, 2. By adjusting the location of screw caps 33, 34 on screws 31, 32, the distance between magnets 1, 2 can be controlled. Because magnets 1, 2 are attracted to each other on the opposite sides the pipe, the aforementioned structure is able to stay fixed at the outer rim of the pipe. However, to prevent separation of the magnets 1, 2 caused by the vibration of the car during traveling, additional screw caps 35, 36 can be added to screws 31, 32 at the parts that extend beyond magnets 1, 2, as shown in FIG. 4. The advantage of this adjusting structure is that it includes only a few elements, and the elements are off-the-shelf inter-exchangeable parts. This further reduces the manufacture cost.

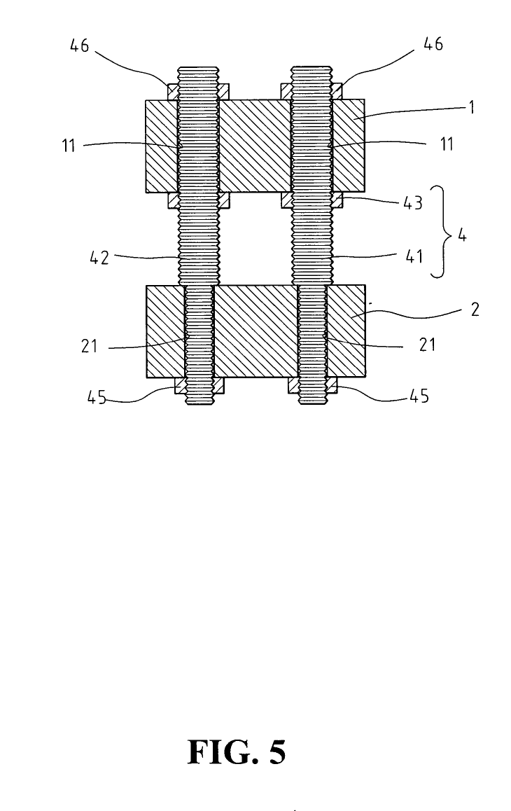

FIG. 5 shows a cross-sectional view of another embodiment of an adjusting structure 4, including twp screws 41, 42, and a plurality of screw caps 43. The difference of this embodiment is that screws 41, 42 have different size of diameter at one end, which penetrates holes 11, 21 of different sizes. Because the diameters are different, screw caps 43 are only placed between magnets 1, 2 for controlling the distance. Additional screw caps 45, 46 can be placed on the extending parts of screws 41, 42 for preventing magnets from falling off.

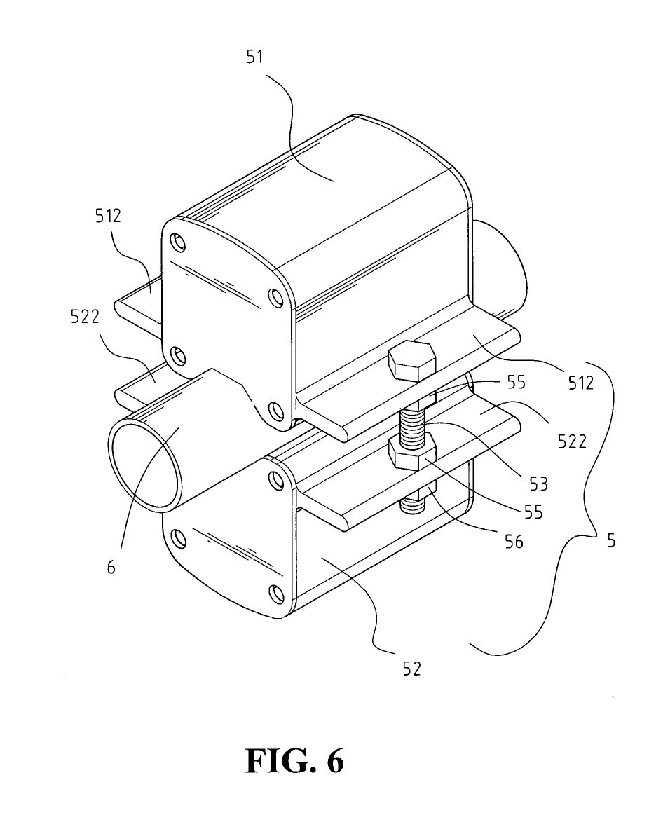

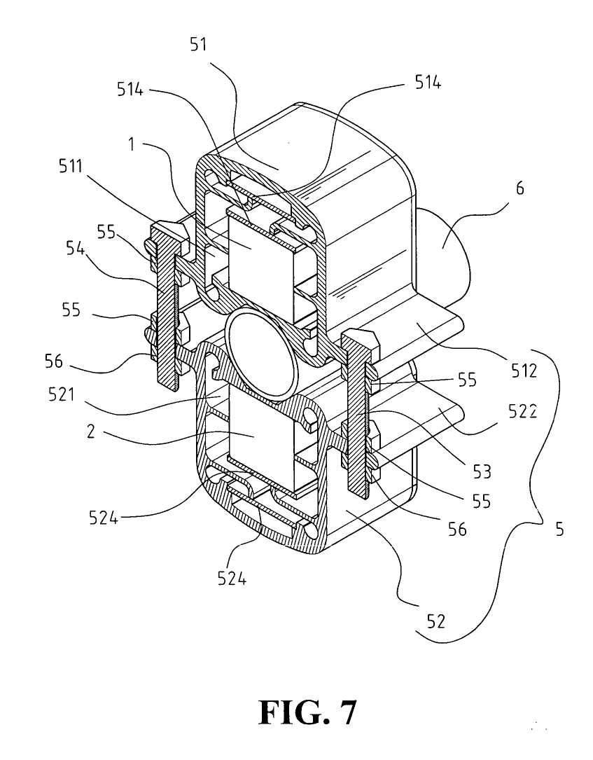

FIG. 6 and FIG. 7 show another embodiment of an adjusting structure 5, including two fixed elements 51, 52, and two fixed screws 53, 54 and a plurality of screws 55. The outer surfaces of fixed elements 51, 52 form a sealed container. The center of the formed container includes receiving spaces 511, 521, in which magnets 1, 2 situate and stay fixed. Extruding planes 512, 522 are on both sides of the container, with penetrated holes for screws 53, 54. The distance between fixed elements 51, 52 is controlled by two screw caps on each screw 53, 54. Additional screw caps 56 can be added to the end of screws 53, 54 to prevent from falling off caused by vibration. The inside of fixed elements 51, 52 further includes a plurality of separators 514, 524, made of magnetic conductive material, such as iron sheet, to reduce the magnetic field outside of fixed elements 51, 52 in order to avoid effecting the electronic products surrounding the pipes. In summary, as the embodiments shown in FIGS. 2, 4, 5, and 6, the adjusting structure is not limited to any specific type or shape. Any structure that can be used to control the distance between the two magnets can be used as the adjusting structure of the present invention.

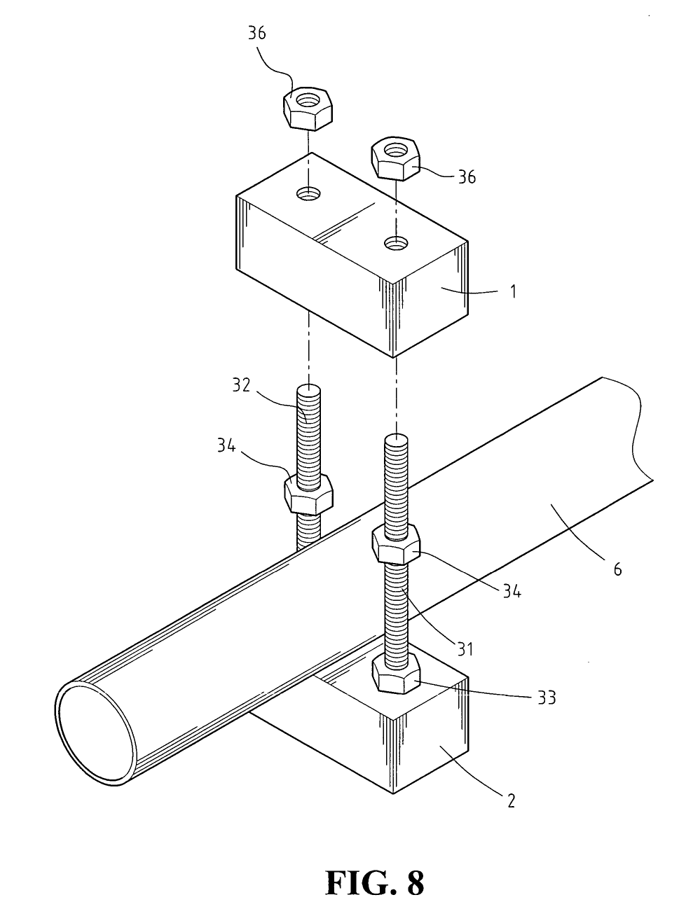

FIG. 8 shows an application of the present invention. When installing the present invention on a fuel hose 6 of a car, it is suggested to start with a large distance between screw caps 33, 34 on screws 31, 32 because magnets 1, 2 exert strong magnetic force. Then, screws 31, 32 penetrate magnet 2 (or magnet 1), and screw cap 35 (not shown) is used to fix at the end of the screws. The entire magnetic device is moved towards fuel hose 6 so that fuel hose 6 is placed between screws 31, 32. The remaining ends of screws 31, 32 then penetrate magnet 1 (or magnet 2). Be sure to make the two magnets having their opposite poles facing each other. Adjusting screw caps 33, 34 so that magnets 1, 2 will slowly move towards fuel pipe 6, and finally the magnets snuggly hugs the fuel hose.

In the above embodiment, the fuel hose is used for explanation. However, the present invention can be used in other applications, such as gas hose or water hose so that the gas or liquid flowing through the hose will be magnetized to improve the combustion efficiency or better absorption in the case of water.

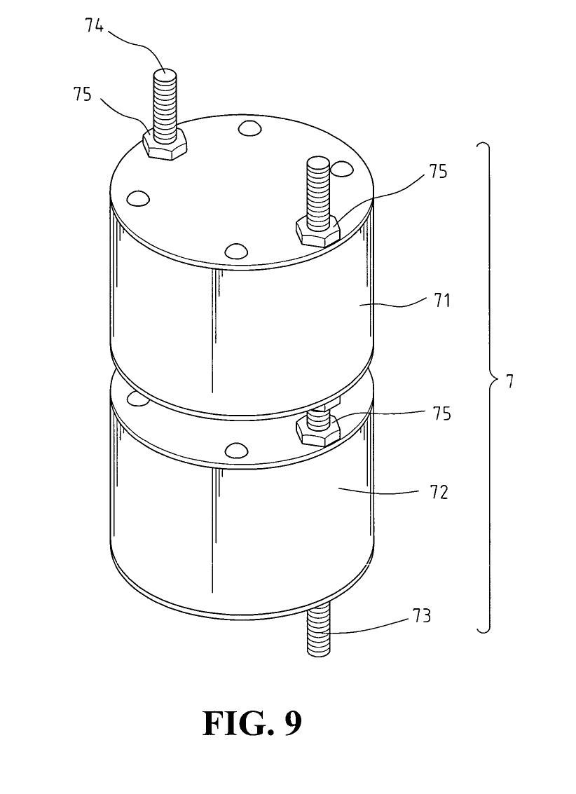

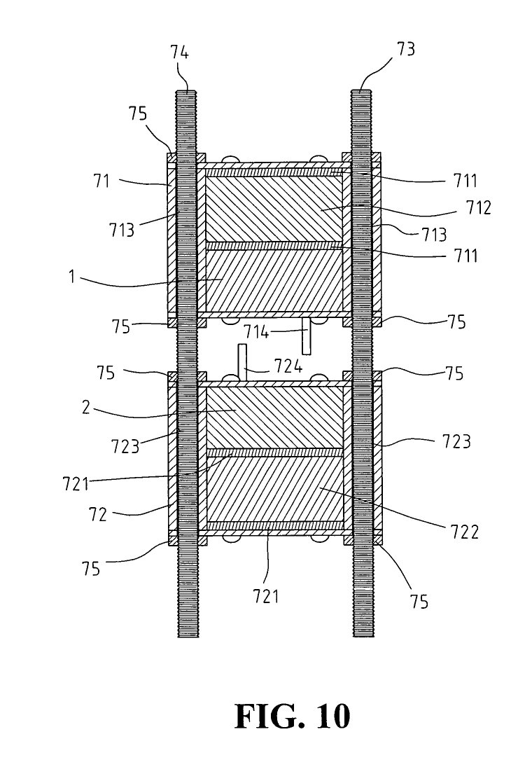

FIG. 9 and FIG. 10 show another adjusting structure 7 of the present invention, including two fixed elements 71, 72, two fixed screws 73, 74, and a plurality of screw caps 75. The outer surfaces of fixed elements 71, 72 form a sealed container. The center of the formed container includes receiving spaces, in which magnets 1, 2 situate and stay fixed. The inside of fixed elements 51, 52 further includes a plurality of separating sheets 711, 721 and a plurality of separating blocks 712, 722. Separating sheets 711, 712 are made of magnetic conductive material, such as iron sheet. Separating blocks 712, 722, and fixed elements 71, 72 are made of non-conductive material. Therefore, the space between two magnets 1, 2 shows a strong magnetic field, while the surrounding area shows a weak magnetic field to avoid effecting the electronic products surrounding the pipes. Holes 713, 723 on fixed elements 71, 72 are for the penetration of screws 73, 74. The distance between fixed elements 71, 72 is controlled by two screw caps 75 on each screw 73, 74. The surfaces of fixed elements 71, 72 facing each other further include extrude blocks 714, 724 for placing the fuel hose.

In the embodiment shown in FIG. 9 and FIG. 10, screws 73, 74 can also be a screw with a larger head on one end so that the number of screw caps used in the structure can be further reduced, as well as simplifying the assembly of the magnetic device.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A magnetic device, comprising:
two magnets, with opposite poles facing each other, placed at a distance; and
an adjusting structure, placed between two said magnets, for adjusting said distance between said magnets.

2. The magnetic device as claimed in claim 1, wherein said magnets are made of magnetic material, with one side as N pole, and the other side as S pole.

3. The magnetic device as claimed in claim 1, wherein said adjusting structure further comprises two long screws and a plurality of screw caps, said long screws penetrate said magnets, and said screw caps are placed on said screw between two said magnets to control said distance between said magnets.

4. The magnetic device as claimed in claim 3, wherein a pipe can be placed between two said magnets and between two said long screws.

5. The magnetic device as claimed in claim 3, wherein said long screws penetrate said magnets and extend beyond said magnets, and screw caps are placed at the ends beyond said magnets.

6. The magnetic device as claimed in claim 1, wherein said adjusting structure further comprises two long screws and a plurality of screw caps, said long screws comprise two parts having different diameters, said long screws penetrate said magnets, and said screw caps are placed on said part with a larger diameter between two said magnets to control said distance between said magnets.

7. The magnetic device as claimed in claim 6, wherein said long screws penetrate said magnets and extend beyond said magnets, and screw caps are placed at the ends beyond said magnets.

8. The magnetic device as claimed in claim 1, wherein said adjusting structure further comprises two fixed elements, two fixed long screws and a plurality of screw caps, said fixed elements comprise receiving space for placing said magnets and extrude plane with holes on both sides, said long screws penetrate said holes, and two said screw caps are placed on said long screws between two said extrude planes to control said distance between said magnets.

9. The magnetic device as claimed in claim 8, wherein screw caps are placed at both ends of said long screws.

10. The magnetic device as claimed in claim 1, wherein said adjusting structure further comprises two fixed elements, two fixed long screws and a plurality of screw caps, said fixed elements comprise receiving space for placing said magnets, and two said screw caps are placed on said long screws between two said extrude planes to control said distance between said magnets.

11. The magnetic device as claimed in claim 10, wherein screw caps are placed at both ends of said long screws.

12. The magnetic device as claimed in claim 1, wherein said fixed elements further comprises a plurality of separating sheets interleaved with a plurality of separating blocks, said separating sheets are made of magnetic conductive material, and said separating blocks are made of non-magnetic-conductive material.

13. The magnetic device as claimed in claim 10, wherein said fixed elements are made of non-magnetic-conductive material.

14. The magnetic device as claimed in claim 10, wherein said fixed elements comprise an extrude block facing each other.
